(19) United States
(12) Patent Application Publication
(10) Pub. No.: US 2010/0048402 A1
(43) Pub. Date: Feb. 25, 2010

(54) TERNARY COMPLEX ON RARE EARTH-AMINO ACID-VITAMIN USED AS PLANT GROWTH REGULATOR AND THE PREPARATION

(76) Inventors: Xiaohua Huang, Jiangsu (CN); Qing Zhou, Jiangsu (CN); Tianhong Lu, Jiangsu (CN); Shaofen Guo, Jiangsu (CN); Cun Li, Jiangsu (CN)

Correspondence Address: SCHMEISER, OLSEN & WATTS, 22 CENTURY HILL DRIVE, SUITE 302, LATHAM, NY, 12110, US

(21) Appl. No.: 12/441,540

(22) PCT Filed: Jun. 18, 2007
(86) PCT No.: PCT/CN07/01912

§ 371 Date: Mar. 17, 2009

(30) Foreign Application Priority Data
Mar. 23, 2007 (CN) 200710021051.2

(51) Int. Cl. A01N 55/02; A01P 21/00

(52) U.S. Cl. 504/191; 504/190

(57) ABSTRACT

The present invention provides a ternary complex on rare earth earth-amino acid-vitamin used as plant growth regulator. The complex has the general formula: RE_{X}-(AA)_{Y}-VI-S_{Z},in which X=1-2;Y=0-2;Z=0-5;RE is a tervalent ion selected optionally from La, Ce, Pr, Nd and Sm; the primary ligand (AA) is amino acid selected from cystine, tyrosine, glycine, glutamic acid, leucine, proline, lysine, phenylalanine, threonine, valine and so on; the secondary ligand VI is vitamin selected from vitamin B, vitamin C, vitamin D and so on, the solvent S is one or more of tetrahydrofuran, methanol, ethanol, and/or dimethylsulfoxide. The yield of plant with root tuber or stem tuber can be increased by 20-56% and the quality thereof can be improved by 1-2 grades when applying such plant growth regulator on the plant. The advantages of the preparation method thereof lie in lesser processes and shorter reaction period.

### TECHNIQUE FIELD

The present invention is related to a regulator for plant growing, the rare earth-amino acid-vitamin ternary regulator for plant growing and its preparation method. The rare earth-amino acid-vitamin ternary regulator for plant growing can increase the quality and output of tuber plants. At the same time, the regulator can reduce the threshold of the damages of the ultraviolet irradiation, the acid rain and the heavy metals.

### TECHNIQUE BACKGROUND

The agricultural use of the rare earth microfertilizers was initiated by Chinese scientists. It is a scientific fruit with the independent intellective property right. The first generation of researchers in the field of the agricultural use of rare earth microfertilizers in China finished the practical dispersion experiments of rare earth elements. During 1980-1985, the over discipline investigation successfully resolved the techniques of the agricultural use of rare earth microfertilizers. Moreover, toxicological hygienics, plant physiology, pedology, manufacture technology and production criterion and so on were investigated. During 1986-1990, the application techniques of the rare earth microfertilizers in the prairie, forest, farming and breed trade were resolved. The agricultural fruits were consolidated and started to extend in the great area. During 1991-1995, the composite fertilizer of the rare earth elements and ammonium carbonate as a representative of the various kinds of the rare earth composite fertilizer was created. During 1996-2000, the combination of the old and new agrotechniques leads the breakthrough of the manner of the agrotechniques of the rare earth microfertilizers. The techniques were extended to the countries, such as Krea etc. in Asia. During 2001-2005, the large amount of the funds was invested into the basic theory research about the agricultural use of rare earth elements and key problems about the persistent development. The synthetical and economic benefits of the community from the agricultural use of rare earth elements was attained over 20000 million Chinese dollars.

By means of the searches of the patent and papers (On-line search), it was known that reasonable use of the rare earth microfertilizers can accelerate the photosynthesis of the plants, enhance the absorption of the nutrient elements, such as nitrogen, phosphorus and potassium by the plants, promote the growth and development of the plants, increase the output, improve the quality as well as decrease the accumulation of pesticide in the plants. For example, after using the rare earth microfertilizers, the photosynthesis efficiency of soybean is enhanced by about 20%, the chlorophyll content is increased by 40% and the output of soybean is lifted by about 55%. However, at present, it was found that the application of the rare earth microfertilizers has some main problems:
(1) Most of rare earth compounds are water soluble. Thus, they are not easy to enter the plant, leading the use of large dosage of the rare earth microfertilizers and only single function of the rare earth microfertilizers can be used.
(2) The study on the biofunction effect of the rare earth microfertilizers is just limited on the level of the planting practice. The study on the mechanism of the function of the rare earth microfertilizers is lacked and the development of new functions of the rare earth microfertilizers is ignored.
(3) The rare earth microfertilizers were considered only as a fertilizer. The rare earth elements in the rare earth microfertilizers would be accumulated in the plants and the background value of the content of the rare earth elements in the environment would be increased. This would affect the food security in China and the export of the agricultural products.

In order to solve the above problems, according the characteristics of the structure of the plant cells and the adversity physiological response combining with the characteristics of the rare earth elements and their complexes, this invention supplies the rare earth-amino acid-vitamin ternary regulator for plant growing with the fattiness-dissolving property. The regulator can adjust the growth and metabolization of the tuber plants, promote the absorption of the organic and inorganic nutrient, increase the chlorophyll content and the photosynthesis efficiency, accelerate the transport of the dried substance, accumulation and secondary metabolization, reduce the content of the heavy metal ions, increase the output (20%˜56%, for average) and quality (1˜2 levels for average) of the plants. No related domestic and overseas literatures and patents are found through the searches by Literature and intelligence Center, Chinese Academy of Sciences.

This invention provides the following technique scheme for this invention. The concrete scheme is as follows:

The general formula of rare earth-amino acid-vitamin ternary regulator for plant growing:

REx-(AA)y-VI-Sz.

Where, X=1˜2; Y=0˜2; Z=0˜5; Y and Z are simultaneously not equal to 0.

RE represents a trivalent ion of La, Ce, Pr, Nd or Sm.

The first coordinator (AA) is an amino acid selected from cystine, tyrosine, histidine, glycine, glutamic acid, leucine, proline, lysine, phenylalanine, threonine, viline, etc.

The second coordinator (VI) is one or more kinds of vitamins selected from vitamin B group, vitamin C group and vitamin D group etc.

S is one or more kinds of solvents selected from tetrahydrofuran, methanol, ethanol and/or dimethylsulfoxide etc.

In other words, the rare earth-amino acid-vitamin ternary regulator for plant growing is the rare earth-amino acid-vitamin ternary complex in the solvent. The molar ratio of its raw materials is as follows:

Rare earth ion: 1˜5

Amino acid: 1˜5

Vitamin: 0.5˜3

Solvent: 5˜20

The general composition formula formed:

REx-(AA)y-VI-Sz.

Where, X, Y and Z would correspond to the value in X=1˜2; Y=0˜2; Z=0˜5, respectively.

In the raw materials, the suitable rare earth ion is a trivalent rare earth ion from nitrate or chloride of La, Ce, Pr, Nd or Sm.

The first coordinator, the suitable amino acid in the raw materials in the regulator is one or more amino acids from cystine, tyrosine, histidine, glycine, glutamic acid, leucine, proline, lysine, phenylalanine, threonine, viline, etc.

The second coordinator, the suitable vitamin in the raw materials in the regulator is one or more kinds of vitamins from corresponding aldehydes of vitamin B group, vitamin C group and vitamin D group etc.

The suitable solvent, S is one or more kinds of solvents among tetrahydrofuran, methanol, ethanol and/or dimethylsulfoxide etc.

In the best scheme, the characteristic of the rare earth-amino acid-vitamin ternary regulator for plant growing contains water and the surfactant. The volume ratio of the regulator and the surfactant is 1˜0.2.

The preparation method of the rare earth-amino acid-vitamin ternary regulator for plant growing includes the following procedures:

The solutions of the rare earth ion, amino acid, vitamin and the solvent are prepared, respectively. The molar ratio of the rare earth ion, amino acid, vitamin and the solvent is 1˜5: 1˜5: 0.5˜3: 5˜20.

The above solutions are mixed and kept at 20˜40° C. for 40˜80 h.

After the color of the solution is changed the concentration, separation and washing are carried out. Finally, the solid powders of the regulator are obtained.

Before the practical application, the invention would increase the following procedures:

In the implement technique of the regulator, the surfactant (A) should be added into sulphite of the regulator. The volume ratio of the regulator and the surfactant is 1:0˜0.2. Both regulator and surfactant are dissolved in the water and then applied to the plants. A is Tween-40.

The rare earth-amino acid-vitamin ternary regulator for plant growing supplied by this invention possesses the plant growing regulator function of “small dosage and large effect”. It changes the traditional idea considering the rare earth element as the fertilizer. Comparing with the rare earth microfertilizers, this regulator not only increases the quality and output of the plants, but also reduces the dosage. Thus, the safety of the agricultural foods is increased.

The preparation method of the rare earth-amino acid-vitamin ternary regulator for plant growing supplied by this invention is simple and the preparation time is short. Thus, the regulator is easy to be prepared.

In order to solve the problems in the usage of the rare earth microfertilizers, according the characteristics of the structure of the plant cells and the adversity physiological response combining with the characteristics of the rare earth elements and their complexes, the invention designs and prepares the rare earth-amino acid-vitamin ternary regulator for plant growing with the fattiness-dissolving property. The regulator can adjust the growth and metabolization of the tuber plants, promote the absorption of the organic and inorganic nutrient, increase the chlorophyll content and the photosynthesis efficiency, accelerate the transport of the dried substance, accumulation and secondary metabolization reduce the content of the heavy metal ions, increase the output (20%˜56%, for average) and quality (1˜2 levels for average) of the plants. No related domestic and overseas literatures and patents are found through the searches by Literature and intelligence Center, Chinese Academy of Sciences.

TABLE 1
The output of horseradish with the treatment times of the rare
earth - amino acid - vitamin ternary regulator for plant growing.

| Time | Output of horseradish/kg | | | | | |
|---|---|---|---|---|---|---|
| 1 | 7.51 | 7.19 | 12.56 | 9.25 | | |
| 2 | | 8.25 | 8.26 | 11.51 | 7.38 | |
| 3 | | | 7.75 | 7.56 | 9.61 | 6.52 |
| 4 | | | | 8.00 | 8.03 | 9.06 |
| 5 | | | | | 7.50 | 8.03 |
| 6 | | | | | | 8.52 |

| | |
|---|---|
| 0 | 7.06(100.00%) |

### APPENDIX: FIGURE CAPTIONS

FIG. 1-1and FIG. 1-2 shows the autoradiographic image of the leafstalk connected with the leaf labeled with the radioactive rare earth ion, Ce(III) as the tracer ion after the usage of the rare earth regulator for 2, 8 and 16 d and the plot of the corresponding radioactivity vs. time. The figures can show the absorption, transfer and dispersion of the rare earth elements in the plant after using the rare earth regulator at the different times (.

FIG. 2-1, FIG. 2-2 and FIG. 2-3 shows the electron microscopic autoradiographs of the radioactive La complexes and radioactive Ce complexes as the regulators in the cell of horseradish. It can be observed from the figures that the rare earth ions at the low concentration are mainly distributed on the membrane of the cell wall to adjust and change in the substance exchange between the inner and exterior of the cell. The rare earth ions at the high concentration are not only distributed on the cell wall, but also entered into the inner of the plant cell to affect the metabolization of the plant.

FIG. 3-1˜FIG. 3-4 show that the rare earth ions at the low concentration are not found to enter into the inner of the cell of horseradish. They are distributed on the membrane of the cell wall of horseradish through the plant outskirt to change in the exchange of the substance and energy between the inner and exterior of the cell. For example, the activity of horseradish peroxidase (HRP) is obviously increased. The Ca²⁺ ions enter the inner of the cell with the suitable amount. The growth of the protoplast is promoted and the content of the nutrient components is increased. FIG. 3-1 shows the TEM images of the distributions of Ca²⁺ ions in the inner and exterior of the cell of horseradish pretreated with the regulator at the low concentration. FIG. 3-2 and FIG. 3-3 show the TEM images of the distribution and activity of HRP in the cell of horseradish without and with the pretreatment of the regulator at the low concentration. FIG. 3-4 is the chromatography of HRP with the high activity index in the plant treated with the low concentration of regulator.

FIG. 4 and FIG. 5 show the effect of the concentration of the external regulator on the concentration of the mineral nutrients in plant.

FIG. 6 shows that the regulator can reduce the damage of the plant by the irradiation of ultraviolet light.

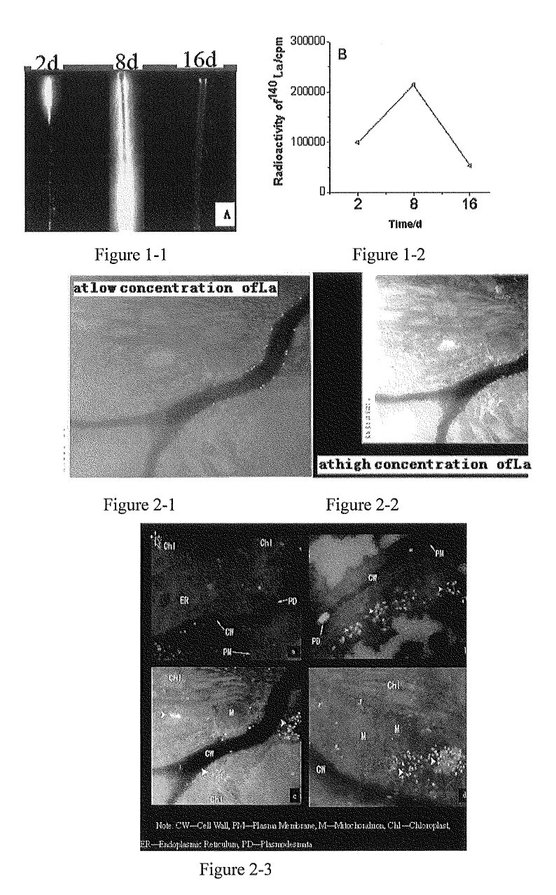

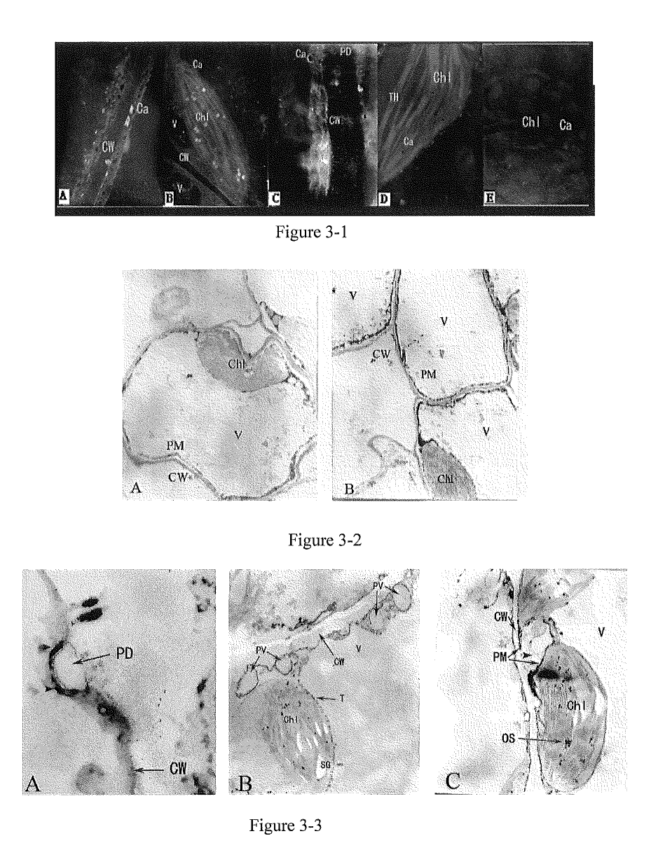

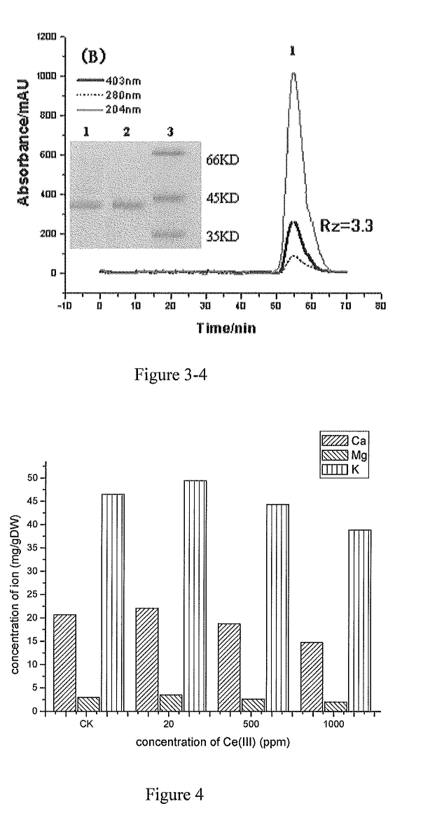

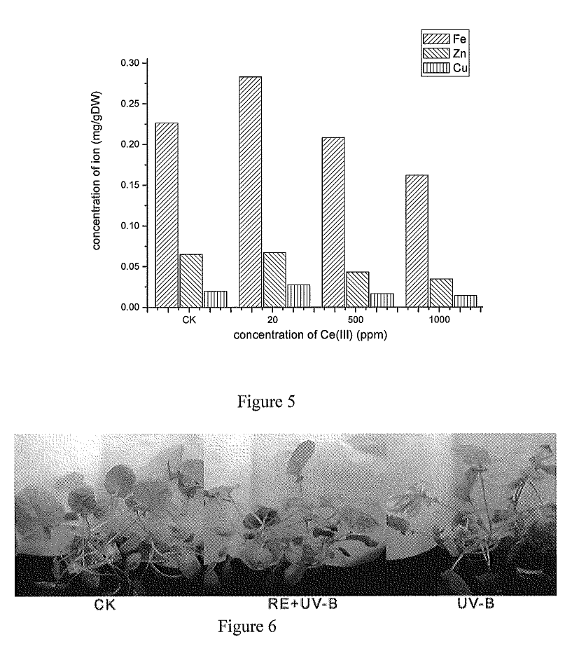

### IDIOGRAPHIC IMPLEMENTARY EXAMPLES

In order to explain clearly the invention, the following examples are listed. However, the examples do not limit the area of the inventions.

### Example 1

The rare earth compound, amino acid, vitamin and the solvent were mixed according to their molar ratio of 1˜5: 1˜5: 0.5˜3: 5˜20. After the mixture solution was kept at 20˜40° C. for 40˜80 h, the color of the solution was changed and the precipitation was obtained. Then, the suspension was concentrated and separated. After the precipitation was clearly washed, the solid powders of the regulator were obtained.

After the regulator was used for horseradish, the average output of horseradish was increased by 25%˜35% and the content of isothiocyanate in horseradish was increased by 5%˜18%.

The regulator used contains La(III) ion, cystine, vitamin B1 and tetrahydrofuran.

### Example 2

The rare earth compound, amino acid, vitamin and the solvent were mixed according to their molar ratio of 1˜5: 1˜5: 0.5˜3: 5˜20. After the mixture solution was kept at 20˜40° C. for 40˜80 h, the color of the solution was changed and the precipitation was obtained. Then, the suspension was concentrated and separated. After the precipitation was clearly washed, the solid powders of the regulator were obtained.

After the regulator was used for rice, the output was increased by 10%˜20%.

The regulator used contains Ce(III) ion, tyrosine, vitamin B2 and methanol.

### Example 3

The rare earth compound, amino acid, vitamin and the solvent were mixed according to their molar ratio of 1˜5: 1˜5: 0.5˜3: 5˜20. After the mixture solution was kept at 20˜40° C. for 40˜80 h, the color of the solution was changed and the precipitation was obtained. Then, the suspension was concentrated and separated. After the precipitation was clearly washed, the solid powders of the regulator were obtained.

After the regulator was used for grape, the output was increased by 15%˜25%. The amount of the soluble solid state-like substance in grape was increased by 0.0%˜2.0%. The content of sugar in grape was increased by 0.0%˜1.9%.

The regulator used contains Pr(III) ion, glycine, vitamin B6 and ethanol.

### Example 4

The rare earth compound, amino acid, vitamin and the solvent were mixed according to their molar ratio of 1˜5: 1˜5: 0.5˜3: 5˜20. After the mixture solution was kept at 20˜40° C. for 40˜80 h, the color of the solution was changed and the precipitation was obtained. Then, the suspension was concentrated and separated. After the precipitation was clearly washed, the solid powders of the regulator were obtained.

After the regulator was used for wheat, the output was increased by 5%˜10%.

The regulator used contains Nd(III) ion, glutamic acid, vitamin B10 and dimethylsulfoxide.

### Example 5

The rare earth compound, amino acid, vitamin and the solvent were mixed according to their molar ratio of 1˜5: 1˜5: 0.5˜3: 5˜20. After the mixture solution was kept at 20˜40° C. for 40˜80 h, the color of the solution was changed and the precipitation was obtained. Then, the suspension was concentrated and separated. After the precipitation was clearly washed, the solid powders of the regulator were obtained.

After the regulator was used for cotton, the output was increased by 10%˜20%.

The regulator used contains Sm(III) ion, glutamic acid, vitamin C, tetrahydrofuran and methanol.

### Example 6

The rare earth compound, amino acid, vitamin and the solvent were mixed according to their molar ratio of 1˜5: 1˜5: 0.5˜3: 5˜20. After the mixture solution was kept at 20˜40° C. for 40˜80 h, the color of the solution was changed and the precipitation was obtained. Then, the suspension was concentrated and separated. After the precipitation was clearly washed, the solid powders of the regulator were obtained.

After the regulator was used for tea, the output was increased by 8%˜12%. The sense quality was increased by 0-1 level.

The regulator used contains La(III) and Ce(III) ions, proline, vitamin D, methanol and ethanol.

### Example 7

The rare earth compound, amino acid, vitamin and the solvent were mixed according to their molar ratio of 1˜5: 1˜5: 0.5˜3: 5˜20. After the mixture solution was kept at 20˜40° C. for 40˜80 h, the color of the solution was changed and the precipitation was obtained. Then, the suspension was concentrated and separated. After the precipitation was clearly washed, the solid powders of the regulator were obtained.

After the regulator was used for peach, the output peach was increased by 10%˜20%. The amount of the soluble solid state-like substance in peach was increased by 0.3%˜1.0%. The content of sugar in peach was increased by 0.0%˜0.5%.

The regulator used contains La(III) and Pr(III) ions, lysine, vitamin B group and vitamin C, tetrahydrofuran and dimethylsulfoxide.

### Example 8

The rare earth compound, amino acid, vitamin and the solvent were mixed according to their molar ratio of 1˜5: 1˜5: 0.5˜3: 5˜20. After the mixture solution was kept at 20˜40° C./ for 40˜80 h, the color of the solution was changed and the precipitation was obtained. Then, the suspension was concentrated and separated. After the precipitation was clearly washed, the solid powders of the regulator were obtained.

After the regulator was used for pear, the output was increased by 10%˜12%. The amount of the soluble solid state-like substance in pear was increased by 0.0%˜0.6%. The content of sugar in pear was increased by 0.0%˜0.9%.

The regulator used contains La(III) and Nd(III) ions, phenylalanine, vitamin B group and vitamin D, methanol, ethanol and dimethylsulfoxide.

### Example 9

The rare earth compound, amino acid, vitamin and the solvent were mixed according to their molar ratio of 1˜5: 15: 0.5˜3: 5˜20. After the mixture solution was kept at 20˜40° C. for 40˜80 h, the color of the solution was changed and the precipitation was obtained. Then, the suspension was concentrated and separated. After the precipitation was clearly washed, the solid powders of the regulator were obtained.

After the regulator was used for apple, the output was increased by 5%˜15%. The amount of the soluble solid state-like substance in apple was increased by 0.0%˜0.5%. The content of sugar in apple was increased by 0.0%˜0.8%.

### Example 10

The rare earth compound, amino acid, vitamin and the solvent were mixed according to their molar ratio of 1˜5: 1˜5: 0.5˜3: 5˜20. After the mixture solution was kept at 20˜40° C. for 40˜80 h, the color of the solution was changed and the precipitation was obtained. Then, the suspension was concentrated and separated. After the precipitation was clearly washed, the solid powders of the regulator were obtained.

After the regulator was used for watermelon, the output was increased by 10%˜20%. The amount of the soluble solid state-like substance in watermelon was increased by 0.0%˜0.8%. The content of sugar in watermelon was increased by 0.0%˜0.5%.

The regulator used contains Ce(II) and Pr(III) ion, viline, vitamin C and vitamin D group, tetrahydrofuran and ethanol.

### Example 11

The preparation method of the regulator and application were the same as before. The regulator used contains several trivalent rare earth ions from La, Ce, Pr, Nd or Sm, several amino acids from cystine, tyrosine, histidine, glycine, glutamic acid, leucine, proline, lysine, phenylalanine, threonine, viline, etc.

The second coordinator, the suitable vitamin in the raw materials in the regulator is one or more kinds of vitamins from corresponding aldehydes of vitamin B group, vitamin C group and vitamin D group etc.

### Example 12

The preparation method of the regulator and application were the same as before.

The regulator used contains no amino acid, but only trivalent rare earth ions, vitamin and solvent.

### Example 13

The preparation method of the regulator and application were the same as before.

The regulator used contains no vitamin, but only trivalent rare earth ion, amino acid and solvent.

We claim:

1. A ternary complex on rare earth-amino acid-vitamin used as plant growth regulator, the complex has the general formula: REX-(AA)Y-VI-SZ,in which X=1-2;Y=0-2;Z=0-5;RE is a tervalent ion selected optionally from La, Ce, Pr, Nd and Sm; the primary ligand (AA) is amino acid selected from cystine, tyrosine, glycine, glutamic acid, leucine, proline, lysine, phenylalanine, threonine, valine and so on; the secondary ligand VI is vitamin selected from vitamin B, vitamin C, vitamin D and so on, the solvent S is one or more of tetrahydrofuran, methanol, ethanol, and/or dimethylsulfoxide.

2. The complex according to claim 1, wherein the rare earth-amino acid-vitamin ternary regulator for plant growing is the rare earth-amino acid-vitamin ternary complex in the solvent, the molar ratio of its raw materials is as follows:
Rare earth ion: 1˜5
Amino acid: 1˜5
Vitamin: 0.5˜3
Solvent: 5˜20
the suitable rare earth ion in the raw materials of the regulator is a trivalent rare earth ion come from nitrate or chloride of La, Ce, Pr, Nd or Sm;
the first coordinator, the suitable amino acid in the raw materials in the regulator is one or more amino acids come from cystine, tyrosine, histidine, glycine, glutamic acid, leucine, proline, lysine, phenylalanine, threonine, viline;
the second coordinator, the suitable vitamin in the raw materials in the regulator is one or more kinds of vitamins come from vitamine B group, vitamine C group,vitamine D group and so on;
the suitable solvent, S is one or more kinds of solvents among tetrahydrofuran, methanol, ethanol and/or dimethylsulfoxide.

3. The complex according to claim 2, wherein the rare earth-amino acid-vitamin ternary regulator for plant growing is that vitamin B is selected from vitamin B 1, vitamin B2, vitamin B6, vitamin B10.

4. The complex according to claim 1, wherein the rare earth-amino acid-vitamin ternary regulator for plant growing is that the rare earth-amino acid-vitamin ternary regulator for plant growing contains water and the surfactant; the volume ratio of the regulator and the surfactant is 1˜0.2.

5. The complex according to claim 4, wherein the rare earth-amino acid-vitamin ternary regulator for plant growing is that the surfactant is tween-40.

6. The preparation method of the rare earth-amino acid-vitamin ternary regulator for plant growing according to claim 1, includes the following procedures:
the solutions of the rare earth ion, amino acid, vitamin and the solvent are prepared, respectively. The molar ratio of the rare earth ion, amino acid, vitamin and the solvent is 1˜5: 1˜5: 0.5˜3: 5˜20;
the above solutions are mixed and kept at 20˜40° C. for 40˜80 h;
after the color of the solution is changed the concentration, separation and washing are carried out. Finally, the solid powders of the regulator are obtained.

7. The method according to claim 6, wherein the method is that after the preparation of the regulator, the rare earth-amino acid-vitamin ternary regulator for plant growing and the surfactant should be dissolved in water according to 1:0˜0.2 volume ratio of the regulator and the surfactant.

8. The method according to claim 7, wherein the preparation method of the rare earth-amino acid-vitamin ternary regulator for plant growing is that the surfactant is tween-40.
